(19) United States
(12) Patent Application Publication
(10) Pub. No.: US 2009/0238268 A1
(43) Pub. Date: Sep. 24, 2009

(54) METHOD FOR VIDEO CODING

(75) Inventors: Chih-Wei Hsu, Taipei City (TW); Yu-Wen Huang, Taipei City (TW); Chih-Hui Kuo, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/052,038

(22) Filed: Mar. 20, 2008

(51) Int. Cl. H04N 7/24

(52) U.S. Cl. 375/240.12

(57) ABSTRACT

A method for video coding is provided. The method comprises retrieving a video frame and at least one reference frame, determining a search window size according to the number of the at least one reference frame, performing prediction encoding on the video frame according to the number of the at least one reference frame and the search window size to obtain coding information and determining another search window size and a number of reference frames according to the coding information.

### BACKGROUND OF THE INVENTION

1. Field of the Invention

The invention relates in general to video coding, and in particular, to a method of motion estimation for video coding.

2. Description of the Related Art

Block-based video coding standards such as MPEG 1/2/4 and H.26x achieve data compression by reducing temporal redundancies between video frames and spatial redundancies within a video frame. Encoders conforming to the standards produce a bitstream decodable by other standard compliant decoders. These video coding standards provide flexibility for encoders to exploit optimization techniques to improve video quality.

One area of flexibility given to encoders is with frame type. For block-based video encoders, three frame types can be encoded, namely I, P and B-frames. An I-frame is an intra-coded frame without any motion-compensated prediction (MCP). A P-frame is a predicted frame with MCP from previous reference frames and a B-frame is a bi-direction predictive frame with MCP from previous and future reference frames. Generally, I and P-frames are used as reference frames for MCP.

Inter-coded frames, including P-frames and B-frames, are predicted via motion compensation from previously coded frames to reduce temporal redundancies, thereby achieving high compression efficiency. Each video frame comprises an array of pixels. A macroblock (MB) is a group of pixels, e.g., 16×16, 16×8, 8×16, and 8×8 block. The 8×8 block can be further sub-partitioned into block sizes of 8×4, 4×8, or 4×4. Thus, 7 block types are supported in total. It is common to estimate how the image has moved between the frames on a macroblock basis, referred to as motion estimation. Motion Estimation typically comprises comparing a macroblock in the current frame to a number of macroblocks from other reference frames for similarity. The spatial displacement between the macroblock in the current video frame and the most similar macroblock in the reference frames is a motion vector. Motion vectors may be estimated to within a fraction of a pixel, by interpolating pixel from the reference frames.

Multi-reference frames and adaptive search window functionality are also provided for motion estimation in video coding standards such as H.264, to support several reference frames and adaptive search window size to estimate motion vectors for a video frame. The quality of motion estimation relies on the selection of reference frames and search window, since software and hardware resource in a video encoder is typically limited, it is crucial to provide a method for video coding capable of selecting a combination of reference frames and search window to optimize motion estimation in different video coding circumstances.

### BRIEF SUMMARY OF THE INVENTION

A detailed description is given in the following embodiments with reference to the accompanying drawings.

A method for video coding is disclosed, comprising retrieving a video frame and at least one reference frame, determining a search window size according to the number of the at least one reference frame, performing prediction encoding on the video frame according to the number of the at least one reference frame and the search window size to obtain coding information and determining another search window size and a number of reference frames according to the coding information.

According to another embodiment of the invention, a method for video coding is provided, comprising retrieving a video frame, determining a maximal number of reference frames for the video frame, determining a search window size according to the maximal number of reference frames, and performing prediction encoding on the video frame according to the maximal number of reference frames and the search window size.

### BRIEF DESCRIPTION OF THE DRAWINGS

The invention can be more fully understood by reading the subsequent detailed description and examples with references made to the accompanying drawings, wherein:

FIG. 1 shows a number of video frames and their possible reference frames.

FIG. 2 shows exemplary selections of reference frames and search window for motion estimation in a video encoder.

FIG. 3 shows an exemplary adaptive video coding method according to the invention.

FIG. 4 is a flow chart illustrating an exemplary method for video coding according to the invention.

FIG. 5 is a flow chart illustrating another exemplary method for video coding according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The quality of motion estimation relies on the number of reference frames and the size of the search window, since software computation power and hardware processing elements in a video encoder are typically limited, a better coding quality may be achieved by selecting a combination of number of reference frames and search window size to adapt to different video coding circumstances.

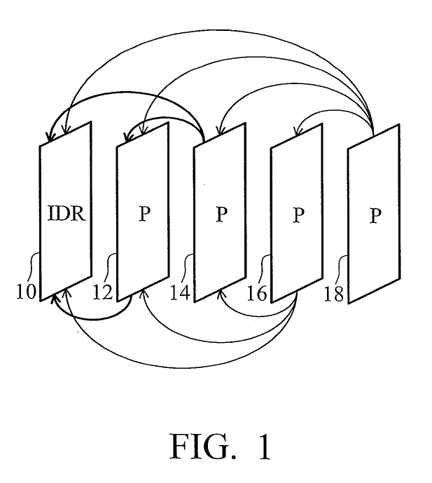

FIG. 1 illustrates a sequence of video pictures from frame 10 to frame 18. Video coding standards such as H.264 utilize instantaneous decoder refresh (IDR) frames to provide key pictures for supporting random access of video content, e.g., fast forwarding operations. The first coded frame in the group of pictures is an IDR frame and the rest of the coded frames are predicted frames (P-frames). Each P-frame is encoded relatively to the available past reference frames in the sequence, including first IDR frame 10. For example, P-frame 12 only uses IDF frame 10 as the reference frame for prediction encoding, P-frame 14 uses frames 10 and 12, and P-frame 18 uses frames 10 to 16 for prediction encoding. Each P-frame is composed of a plurality of macroblocks, and each macroblock may be an intra-coded macroblock or inter-coded macroblock. The intra-coded macroblocks are encoded in the same manner as those in an I-frame. The inter-coded macroblocks are encoded by reference frames in conjunction with residue terms. A motion vector for prediction encoding is calculated to represent a spatial displacement between the macroblock in the current video frame and the most similar macroblock in the reference frame. A block matching metric, such as Sum of Absolute Differences (SAD) or Mean Squared Error (MSE), can be used to determine the level of similarity between the current macroblock and those in the reference frame for determination of motion vector. Typically, the most similar macroblock is searched within a predetermined search window size in a reference frame. While a large search window size yields high search coverage for a given macroblock, it also results in the speed degradation of the video encoder due to heavy computation loading. The predetermined search window size may be identical for all the reference frames, or adaptive depending on other factors, such as the number of reference frames. For example, selection of the search window size may be adaptive according to the number of reference frames, with the search window size being inversely proportional to the number of reference frames, thereby sustaining approximately constant computation loading. The residue term is encoded using discrete cosine transform (DCT), quantization, and run-length encoding.

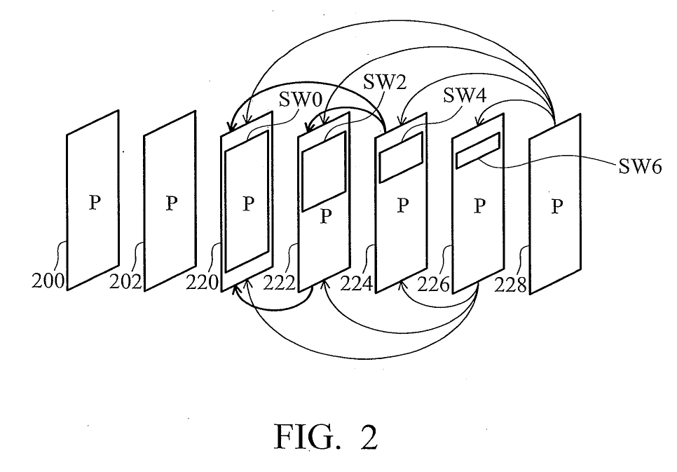

FIG. 2 shows video frames 200 to 228 for illustrating another exemplary video coding algorithm. FIG. 2 illustrates an example of video coding upon a scene change. Prior to video encoding, the video encoder receives video frame and determines the occurrence of scene changes. For example, the video encoder detects a scene change in video frame 220, therefore encoding all or most of the macroblocks in video frame 220 by intra-coded macroblocks. Since the scene change occurs at video frame 220, video frames 222 to 228 have no relevance to video frames prior thereto, thus P frames following scene changed frame 220 are employed as reference frames for prediction encoding. The video encoder may utilize the number of the reference frames to determine the search window size of the reference frame to search for the most similar macroblock and compute a motion vector. In the embodiment, frame 222 uses a single reference frame 220 and a large search window SW0 for prediction encoding, and frame 228 uses frames 220 through 226 as the reference frames and smaller search windows SW6. The search window size may be determined according to the number of available reference frames for each video frame to be encoded, and may be identical for each reference frame, e.g., frames 220 through 226 share identical search window size SW6 for performing prediction decoding for video frame 228. The search window size may be inversely proportional to the number of the reference frames, and the combination of each search window size and number of the reference frames pair may be stored in the video encoder as a lookup table, so that the video encoder can search for a corresponding search window size by the number of available reference frames.

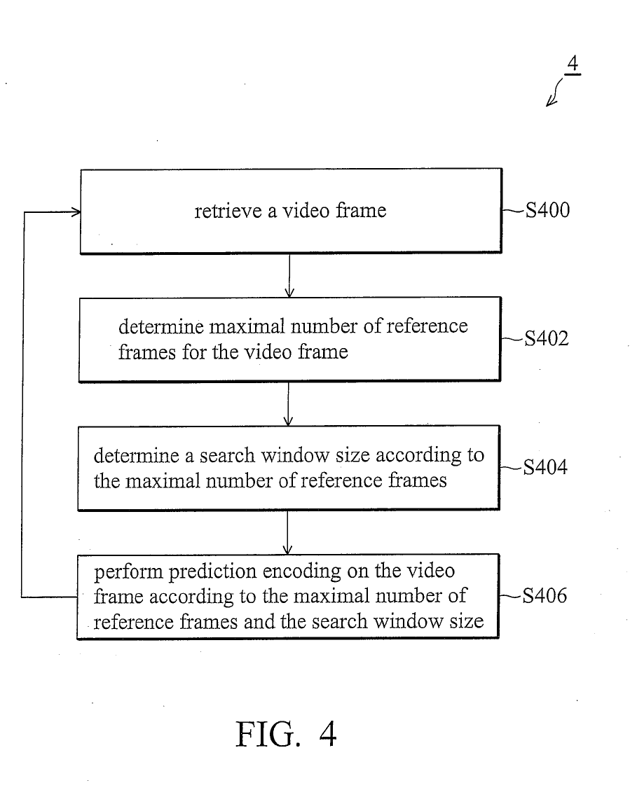

Refer now to FIG. 4 for a flow chart illustrating an exemplary method for video coding according to an embodiment of the invention, incorporated in FIGS. 1 and 2.

In Step S400, a video frame is retrieved for encoding. Next in Step S402, the video encoder determines a maximal number of reference frames for the video frame. Taking FIG. 1 as an example, the encoder utilizes all available reference frames following the closest previous IDR frame for video encoding, frame 12 has a maximal number of reference frames as one (IDR frame 10), and frame 18 has 4 reference frames (frames 10˜16). Alternatively, the encoder may also use all available reference frames following the closest previous scene changed frame as shown in FIG. 2. For example, frame 222 has a maximal number of reference frames as one (frame 220), and frame 228 has 4 reference frames (frames 220˜226).

Next in Step S404, a search window size is determined according to the maximal number of reference frames. The search window size may be determined according to inverse proportion of the maximal number of reference frames. For example, frame 228 employs a number of reference frames 4 times that of frame 222, and the search window size SW6 for each reference frame of frame 228 is around a quarter that of search window SW0 for the reference frame of frame 222.

Then in step S406, the video encoder performs prediction encoding on the video frame according to the maximal number of reference frames and the search window size. The video encoding method then returns to Step S400 to perform video encoding for the next video frame.

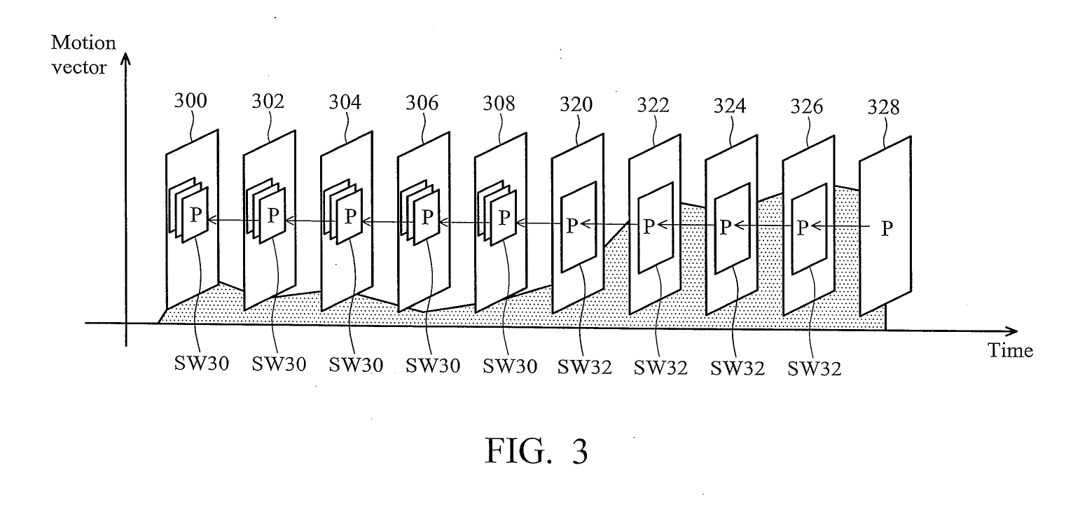

FIG. 3 shows a sequence of video frames 300 to 328 illustrating another exemplary video coding according to an embodiment of the invention, where the horizontal axis represents time and vertical axis represents motion vector.

FIG. 3 illustrates adaptive video encoding, and the graph in the background demonstrates change in motion vector from frames to frames. A combination of the number of reference frames and the search window size may be determined according to video source characteristics, such as motion, level of details, or texture. In this embodiment, the number of reference frames and the search window size are selected based on motion statistics. For example, motion of video frames may be classified into slow and fast motion according to coding information such as motion vectors. The video encoder determines a video frame as fast motion or slow motion, for example, by comparing the an averaged motion vector with a predetermined threshold, and determining the video frame as fast motion when the averaged motion vector exceeds the predetermined threshold, or slow motion when otherwise. In this embodiment, video frames 300 to 308 have averaged motion vectors less than the predetermined threshold and are classified as slow motion, whereas video frames 320 to 328 are classified as having fast motion. The video encoder may assign a predetermined combination of the number of reference frames and the search window size for each video frame according to its motion statistics from preceding prediction encoding. Next, each video frame would then perform prediction encoding and generate coding information such as motion vectors for later selection of the number of reference frames and search window size. For example, video frames 300 through 308 are slow motion frames, thus the video encoder assigns three reference frames and a relatively small search window size for the successive frames 302 to 320. The video encoder determines video frames 320 to 328 are fast motion frames, thus assigns one reference frame and a relatively large search window size to these fast motion frames.

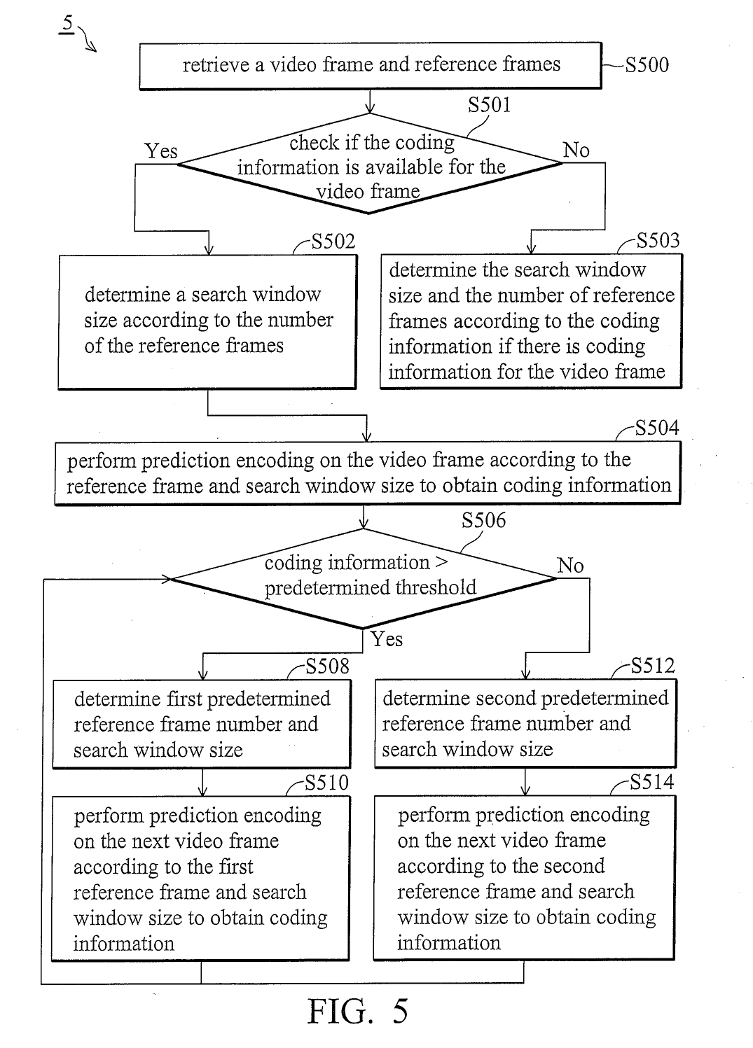

Refer to FIG. 5 for an exemplary flow chart for video coding according to the invention, incorporated in FIG. 3.

In Step S500, video frame 300 and reference frames are retrieved. For example, the reference frames may be the maximal number of reference frames following by an IDR frame or a scene changed frame.

In step S501, the video encoder checks if the coding information is available for frame 300, carries out step S502 if not, and step S503 if available. The coding information may be motion estimators.

Next in Step S502, the video encoder determines a search window size according to the number of the reference frames for frame 300. The search window size may be determined according to the number of the reference frames when the number of the reference frames is less than a predetermined reference frame number, and determined according to the predetermined reference frame number when the number of the reference frame equals to or exceeds the predetermined reference frame number. In one embodiment, the predetermined reference frame number is 3. Taking FIG. 3 as an example, frame 300 is the first prediction frame immediately after an IDF, the number of the reference frames is one, thus the search window size is determined according to one reference frame (i.e., the IDF frame). Like wise, the search window size for frame 302 is determined according to two reference frames, i.e., the IDF frame and frame 300. In frame 306, the number of available reference frames includes the IDF frame and frames 300 through 304, exceeding the predetermined reference frame number 3, thus 3 preceding reference frames (the IDF, frames 300 and 302) are employed for search window size determination.

In step S503, the video encoder determines the search window size and the number of reference frames according to the coding information if there is coding information for video frame 300.

Then in Step S504, the video encoder performs prediction encoding on video frame 300 according to the reference frames and search window size to obtain coding information, such as motion vectors.

In Step S506, the video encoder compares the coding information with a predetermined threshold to determine whether the coding information exceeds the predetermined threshold, proceeds to Step S508 if so, or Step S512 if otherwise. For example, the video encoder compares the averaged motion vector of frame 300 with the predetermined threshold, and determines the frame 300 is slow motion (proceeds to Step S512). The video encoder compares the averaged motion vector of frame 320 with the predetermined threshold, and determines the frame 320 is a fast motion frame (proceeds to Step S508).

In Step S508, the video encoder determines a first predetermined number of reference frames and search window size for frames with coding information exceeds the predetermined threshold. The first predetermined number of reference frames and search window size may be dedicated for fast motion when large search area on a reference frame is desirable. For example, as shown in FIG. 3, the first predetermined number of reference frames may be 1 and search window size may be SW32.

Then in Step S510, the video encoder performs prediction encoding on the next video frame according to the first predetermined number of reference frames and search window size to obtain coding information. In this embodiment, as shown in FIG. 3, the video encoder performs prediction encoding on frame 322 with single reference frame 320 and search window size SW32 to obtain coding information including motion vectors. Video coding method 5 then returns to Step S506 to perform the comparison between the coding information and predetermined threshold, thereby deriving the number of reference frames and search window size to be used for the next video frame.

In Step S512, the video encoder determines a second predetermined number of reference frames and search window size if the coding information is less than the predetermined threshold. The second predetermined number of reference frames and search window size are dedicated for slow motion when small search area on multiple reference frames is desirable. For example, as shown in FIG. 3, the second predetermined number of reference frames is 3 and search window size is SW30. The size of search window SW32 may exceed that of search window SW30.

Then in Step S514, prediction encoding on the next video frame according to the second predetermined number of reference frames and search window size to obtain coding information is performed. The first search window size exceeds the second search window size, and the second number of reference frames exceeds the first number of reference frames. For example, as shown in FIG. 3, the video encoder performs prediction encoding on the frame 302 with three preceding reference frames and search window size SW30 to obtain coding information including motion vectors. Video coding method 5 then returns to Step S506 to perform the comparison between the coding information and predetermined threshold, thereby obtaining the number of reference frames and search window size to be used for the next video frame.

While only predicted frames are utilized in the exemplary embodiments of video coding in FIGS. 1 through 5, those with ordinary skill in the art could readily recognize that bi-predictive frames may also be incorporated into the invention with appropriate modifications.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for video coding, comprising:
retrieving a video frame and at least one reference frame;
determining a search window size according to the number of the at least one reference frame;
performing prediction encoding on the video frame according to the search window size and the number of the at least one reference frame to obtain coding information; and
determining another search window size and a number of reference frames according to the coding information.

2. The method for claim 1, further comprising the following steps before the step of determining the search window size according to the number of the at least one reference frame:
checking if there is coding information for the video frame; and
determining the search window size and the number of reference frames according to the coding information if there is coding information for the video frame;
wherein the method proceeds to the step of determining a search window size according to the number of the at least one reference frame if there is no coding information for the video frame.

3. The method for claim 1, wherein:
the another search window size and the number of reference frames are a first predetermined search window size and number of reference frames if the coding information indicates slow motion; and
the another search window size and the number of reference frames are a second predetermined search window size and number of reference frames different from the first if the coding information indicates fast motion.

4. The method for claim 1, wherein the determination of the search window size comprises:
determining the search window size according to the number of the at least one reference frame less than a predetermined reference frame number; and
determining the search window size according to the predetermined reference frame number when the number of the at least one reference frame equals to or exceeds the predetermined reference frame number.

5. The method for claim 1, wherein the coding information is a motion vector, the coding information indicates the slow motion when the motion vector is less than a motion vector threshold, and the coding information indicates the fast motion when the motion vector exceeds than the motion vector threshold.

6. The method for claim 1, wherein the second search window size exceeds the first search window size, and the first number of reference frames exceeds the second number of reference frames.

7. The method for claim 1, wherein the number of reference frames is the maximal number of available reference frames of the video frame after an immediately preceding IDR frame.

8. The method for claim 1, wherein the number of reference frames is the maximal number of available reference frames of the video frame after an immediately preceding frame with a scene change.

9. The method for claim 1, wherein the prediction encoding is predictive or bi-predictive encoding.

10. A method for video coding, comprising:
retrieving a video frame;
determining a maximal number of reference frames for the video frame;
determining a search window size according to the maximal number of reference frames; and
performing prediction encoding on the video frame according to the maximal number of reference frames and the search window size.

11. The method for claim 10, wherein the search window size is inversely proportional to the maximal number of reference frames.

12. The method for claim 10, wherein the determination of the maximal number of reference frames comprises assigning all reference frames successive to an instantaneous decoder refresh (IDF) frame in a group of pictures as the reference frames of the video frame.

13. The method for claim 10, further comprising detecting a scene changed frame having a scene change, wherein the determination of the maximal number of reference frames comprises assigning all reference frames successive to the scene changed frame as the reference frames of the video frame.

14. The method for claim 10, wherein the prediction encoding is predictive or bi-predictive encoding.
